(19) United States
(12) Patent Application Publication
(10) Pub. No.: US 2022/0222518 A1
(43) Pub. Date: Jul. 14, 2022

(54) DYNAMIC COMPENSATION OF ANALOG CIRCUITRY IMPAIRMENTS IN NEURAL NETWORKS

(71) Applicant: Intel Corporation, Santa Clara, CA (US)

(72) Inventors: Hechen Wang, Portland, OR (US); Kuilin Clark Chen, Portland, OR (US)

(73) Assignee: Intel Corporation, Santa Clara, CA (US)

(21) Appl. No.: 17/709,796

(22) Filed: Mar. 31, 2022

(51) Int. Cl. G06N 3/063; G06V 10/774; G06F 7/544

(52) U.S. Cl. CPC G06N 3/0635; G06F 7/5443; G06V 10/7747

(57) ABSTRACT

Dynamic compensation of analog circuitry impairments in ANNs is provided. An example ANN includes an analog circuitry that performs MAC operations based on weights. To compensate analog circuitry impairments, a signal package including a training signal and an input signal, is formed. The training signal is fed into the ANN. The ANN generates an output signal through MAC operations by the analog circuitry with the training signal and the weights. The output signal is compared with a reference signal to determine an error in the output signal. The reference signal may include one or more ground-truth classifications of the training signal. The error is used to compute a compensation coefficient, which compensates impact of analog circuitry impairments on accuracy in outputs of the ANN. The ANN is updated with the compensation coefficient. The analog circuitry performs MAC operations with the input signal, the compensation coefficient, and the set of weights.

### TECHNICAL FIELD

This disclosure relates generally to neural networks, and more specifically, to analog neural networks.

### BACKGROUND

Deep neural networks (DNNs) are characterized by the ability to produce effective representations of data using automatic latent feature extraction. To accomplish this, DNNs are substantially more complex compared to more traditional machine learning techniques and require many orders of magnitude more parameters to be trained. Analog compute in-memory (ACiM) is a promising scheme to realize high efficiency DNNs. In the ACiM scheme, analog circuitry, as opposed to digital machine learning processor, is used to perform multiply-accumulate (MAC) operations. DNNs including such analog circuitry are generally referred to as analog neural networks (ANNs).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a layered architecture of an example ANN, in accordance with various embodiments.

FIG. 2 is a block diagram of an example ANN system, in accordance with various embodiments.

FIG. 3 is a block diagram of an example compensation module, in accordance with various embodiments.

FIG. 4 illustrates an example compensation operation for an ANN that performs one-category classifications, in accordance with various embodiments.

FIG. 5 illustrates an example compensation operation for an ANN that performs multi-category classifications, in accordance with various embodiments.

FIG. 6 illustrates an example training signal for a compensation operation, in accordance with various embodiments.

FIG. 7 illustrates another example training signal for a compensation operation, in accordance with various embodiments.

FIG. 8 is a flowchart showing an example method for compensating analog circuitry impairments in an ANN, in accordance with various embodiments.

FIG. 9 is a block diagram of an example computing system, in accordance with various embodiments.

### DETAILED DESCRIPTION

Overview

An ANN includes an array of ACiM devices, which can execute a large amount of MAC operations simultaneously. The MAC operation unit in the analog domain can be just a tunable resistor, an adjustable delay cell, or several switching capacitors. Such MAC operation unit is much simpler than digital arithmetic units. Thus, ANNs have overwhelming advantages over the conventional schemes, e.g., in terms of power and area efficiency. With such advantages, ANNs are used for edge-computing based AI (artificial intelligence) or edge AI.

Edge AI provides proximity of computation and data storage to the sources of data, as opposed to the data center or central cloud, and thereby, reduces latency in data transfer and decision making. Computing at the edge also has a lot of constrains. One of the constraints is power limitation, since many devices at the edge, such as wireless sensors, mobile devices, have very limited power sources. To improve the flexibility and mobility, edge devices are usually powered by battery. However, intensive operations can drain the battery quickly. To save power, a common solution is to lower the supply voltage of the circuit. However, with lower supply voltage, analog circuits are more sensitive to noise and ambient environment variations, which will cause error during computation and lead to failure in the classification. ACiM is also suffering from additional implementation mismatch and process variations when compared with digital counterparts. Although DNNs can tolerate some level of errors or noise, as neural networks mimic the human brain and they are able to handle some faults during the processing, the accuracy of the results will face great degradation.

Impairments in analog circuits are unavoidable due to manufacturing mismatches, implementation mismatches, process-voltage-temperature (PVT) variations, and so on. Such hardware impairments lead to errors in outputs of ANNs. Errors in ANN outputs can be gain errors or offset errors. Offset errors can be removed by using differential signals. However, gain errors cannot be removed without gain compensation. Therefore, a compensation mechanism is required to mitigate the impact of analog circuitry impairments in ANNs. One challenge for developing an effective compensation mechanism is that classification failures can result from either hardware defect or input data corruption. Conventional technologies fail to distinguish these two types of failures.

A method to compensate hardware impairments in analog computing is static mismatch error compensation. Static mismatch error compensation is based on the implicit assumption that the mismatch due to process variation does not change anymore after the fabrication. Therefore, the coefficient to compensate the mismatch can be a set of constant data. However, compensating the first order process variation is insufficient, as mismatches in resistors, capacitors, or delay cells are also related to the actual operation condition. As a result, this static offline calibration may lead to a great performance degeneration in some circumstances.

Another method is dynamical adjustment of operation conditions. This method typically adjusts operation conditions (e.g., voltage, current, etc.) based on classification failure rate. This method has multiple problems. First, the classification failure has two causes, computing fault and input corruption, but it is hard to distinguish these two by simply monitoring the classification failure rate. Second, to calculate the classification failure rate, data from data center is required, but the edge device cannot figure out if it is failure by its own, additional data transmission is required. Third, this method requires waiting for data and processed results from the data center, the delay in the voltage control loop is unbounded, which can easily cause instability and oscillation in the loop. Fourth, voltage tuning cannot alleviate the impact of temperature and process variations. Therefore, improved technologies for compensating analog circuitry impairments in ANNs are needed.

Embodiments of the present disclosure may improve on at least some of the challenges and issues described above by providing dynamic compensation of analog circuitry impairments in ANNs through automatic optimization of compensation coefficients. An example ANN, which has been trained, includes an analog circuitry that performs MAC operations with analog data. Weights for the MAC operations have been determined through the training. The analog circuitry may be an electronic circuit that includes analog components, such as transistors, capacitors, resistors, diodes, and so on. To compensate impairments of the analog circuitry, a signal package is formed. The signal package includes a training signal (e.g., as preamble) and an input signal (e.g., as payload data) that can be fed into the ANN sequentially. The training signal is associated with a reference signal that includes one or more ground-truth classifications of the training signal. The training signal is fed into the ANN first. The analog circuitry performs MAC operations based on the training signal and the weights. The ANN generates an output signal based on the MAC operations. The output signal may include one or more classifications of the training signal. The output signal is compared with the reference signal to determine an error signal. The error signal is used to generate a compensation coefficient set that includes one or more compensation coefficients. The ANN is then updated with the compensation coefficient set. After the ANN is updated, the input signal in the signal package is fed into the ANN. The analog circuitry in the ANN can perform MAC operations based on the input signal, the compensation coefficient set, and the weights. For instance, the MAC operations include multiplying a compensation coefficient with a weight.

The incorporation of compensation coefficients into MAC operations can compensate the impact of analog circuitry impairments on the accuracy of the ANN's output. And, by packaging the training signal with real input signal, the interruption to the operation of the ANN by the compensation process can be minimized. Furthermore, the compensation can be dynamic. For instance, the compensation can be done constantly or periodically (e.g., at a predetermined frequency). The compensation coefficients can be automatically tuned, e.g., by using an adaptive algorithm, in every compensation operation based on the ANN's process of the preamble. Also, the generation of the error signal is sensitive to faults introduced by hardware impairments and is not misguided by input data corruption. Thus, in embodiments where the ANN is used for edge AI computing, the compensation does not require any assistance from the data center for network retraining, which can greatly reduce the communication bandwidth and delay between the edge device and the data center.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

In addition, the terms “comprise,” “comprising,” “include,” “including,” “have,” “having” or any other variation thereof, are intended to cover a non-exclusive inclusion. For example, a method, process, device, or sparsity balancing system that comprises a list of elements is not necessarily limited to only those elements but may include other elements not expressly listed or inherent to such method, process, device, or sparsity balancing system. Also, the term “or” refers to an inclusive “or” and not to an exclusive “or.”

The sparsity balancing systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example ANN Architecture

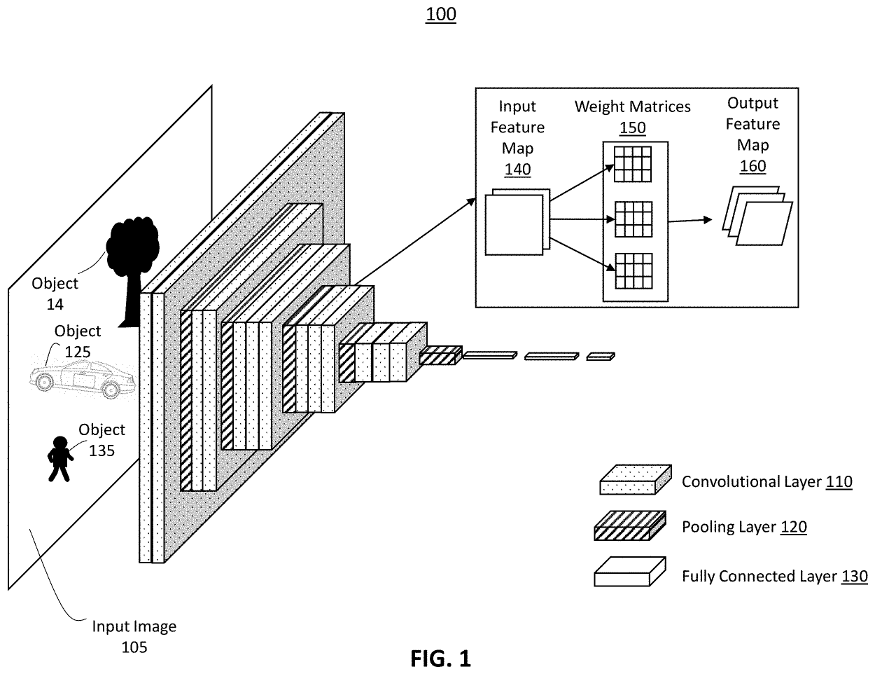

FIG. 1 illustrates a layered architecture of an example ANN 100, in accordance with various embodiments. The ANN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the ANN 100 may include fewer, more, or different layers. The ANN 100 100 is implemented with analog devices and operates in the analog domain. One or more layers of the ANN 100 (e.g., convolutional layers 110) may include an analog circuitry to perform MAC operations on analog input signals. The output of a layer may also be analog signals. Even though not shown in FIG. 1, the ANN 100 may include one or more analog-to-digital converters that convert analog signals to digital signals, or one or more digital-to-analog converters that convert digital signals to analog signals. For purpose of illustration, the ANN 100 in FIG. 1 is trained to receive images and output classifications of objects in the images. In the embodiment of FIG. 1, the ANN 100 receives an input image 105 that includes objects 115, 125, and 135.

The convolutional layers 110 summarize the presence of features in the input image 105. The convolutional layers 110 function as feature extractors. The first layer of the ANN 100 is a convolutional layer 110. In an example, a convolutional layer 110 performs a convolution to an IFM (input feature map) 140 by using weight matrices 150, generates an OFM (output feature map) 160 from the convolution, and passes the OFM 160 to the next layer in the sequence. The IFM 140 may include a plurality of IFM matrices. The OFM 160 may include a plurality of OFM matrices. For the first convolutional layer 110, which is also the first layer of the ANN 100, the IFM 140 is the input image 105. For the other convolutional layers, the IFM 140 may be an output of another convolutional layer 110 or an output of a pooling layer 120. The convolution is a linear operation that involves the multiplication of the weight matrices 150 with the IFM 140. A filter may be a 2-dimensional array of weights. Weights of the filters can be initialized and updated by backpropagation using gradient descent. The magnitudes of the weights of the filters can indicate importance of the weight matrices 150 in extracting features from the IFM 140. A filter can be smaller than the IFM 140.

The multiplication applied between a filter-sized patch of the IFM 140 and a filter may be a dot product. A dot product is the element-wise multiplication between the filter-sized patch of the IFM 140 and the corresponding filter, which is then summed, always resulting in a single value. Because it results in a single value, the operation is often referred to as the “scalar product.” Using a filter smaller than the IFM 140 is intentional as it allows the same filter (set of weights) to be multiplied by the IFM 140 multiple times at different points on the IFM 140. Specifically, the filter is applied systematically to each overlapping part or filter-sized patch of the IFM 140, left to right, top to bottom. The result from multiplying the filter with the IFM 140 one time is a single value. As the filter is applied multiple times to the IFM 140, the multiplication result is a two-dimensional array of output values that represent a filtering of the IFM 140. As such, the 2-dimensional output array from this operation is referred to a “feature map.”

In some embodiments, the OFM 160 is passed through an activation function. Example activation functions include rectified linear unit (ReLU) or tanh. The convolutional layer 110 may receive several images as input and computes the convolution of each of them with each of the filters. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new filters and generates a new feature map. The new feature map may also be normalized and resized. The new feature map can be filtered again by a further subsequent convolutional layer 110, and so on.

In some embodiments, a convolutional layer 110 has four hyperparameters: the number of filters, the size F filters (e.g., a filter is of dimensions F×F×D pixels), the S step with which the window corresponding to the filter is dragged on the image (e.g., a step of 1 means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The ANN 100 includes 16 convolutional layers 110. In other embodiments, the ANN 100 may include a different number of convolutional layers.

The pooling layers 120 downsample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input vector. The input vector defines the output of the convolutional layers 110 and pooling layers 120 and includes the values of the last feature map generated by the last pooling layer 120 in the sequence. The fully connected layers 130 applies a linear combination and an activation function to the input vector and generates an output vector. The output vector may contain as many elements as there are classes: element i represents the probability that the image belongs to category i. Each element is therefore between 0 and 1, and the sum of all is worth 1. These probabilities are computed by the last fully connected layer 130 by using a logistic function (binary classification) or a softmax function (multi-category classification) as an activation function.

In some embodiments, the fully connected layers 130 classify the input image 105 and returns a vector of size N, where N is the number of classes in the image classification problem. In the embodiment of FIG. 1, N equals 3, as there are three objects 115, 125, and 135 in the input image. Each element of the vector indicates the probability for the input image 105 to belong to a category. To compute the probabilities, the fully connected layers 130 multiply each input element by weight, makes the sum, and then applies an activation function (e.g., logistic if N=2, softmax if N>2). This is equivalent to multiplying the input vector by the matrix containing the weights. In an embodiment, the output vector includes three probabilities, each of which corresponds to a classification of an object. For instance, the three probabilities may include a first probability indicating the object 115 being a tree, a second probability indicating the object 125 being a car, and a third probability indicating the object 135 being a person. In other embodiments where the input image 105 includes different objects or a different number of objects, the output vector can be different. Also, the output vector may include multiple probabilities for a single object, each probability corresponds to a different category and indicates the likelihood of the object being in the category.

Example ANN System

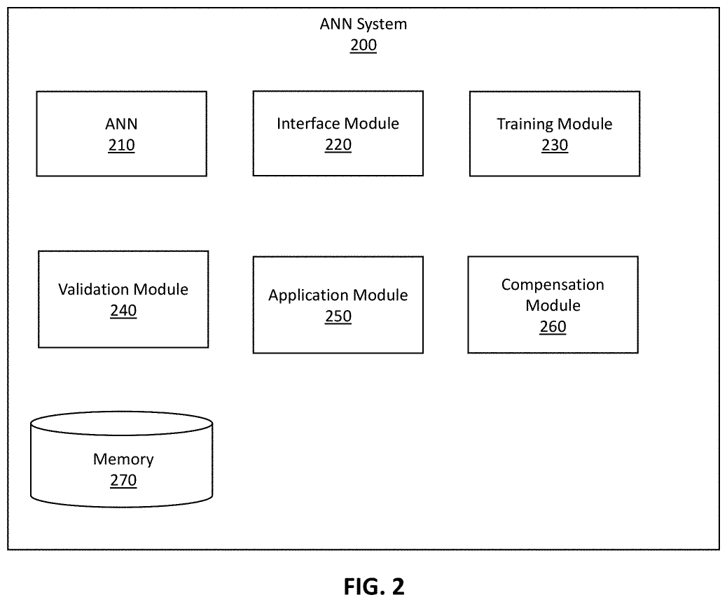

FIG. 2 is a block diagram of an example ANN system 200, in accordance with various embodiments. The ANN system 200 includes an ANN 210, an interface module 220, a training module 230, a validation module 240, an application module 250, a compensation module 260, and a memory 270. As used herein, the term “module” refers to a unit that provides the specified functionality. A module may be implemented in hardware (e.g., analog circuit, digital circuit, etc.), firmware, software, or some combination thereof. In other embodiments, alternative configurations, different or additional components may be included in the ANN system 200. Further, functionality attributed to a component of the ANN system 200 may be accomplished by a different component included in the ANN system 200 or a different system.

The ANN 210 is a neural network that operates in the analog domain. The ANN 210 may be trained, e.g., by the training module 230, to perform a task or various tasks, such as classification, prediction, clustering, associating, controlling, or other types of tasks. The ANN 210 may be used for various applications, such as image processing, natural language processing, bioinformatics, drug design, social network, robotics, and so on. An embodiment of the ANN 210 is the ANN 100 in FIG. 1. The ANN 210, or a part of it (e.g., a layer of the ANN 210), may include an array of ACiM devices (“ACiM array”). In some embodiments, the ANN 210 performs edge AI computing. For instance, the ANN 210 operates at an edge coupled to a data center. The data center may be implemented in the cloud. The data center may transfer input signals to the ANN 210, where MAC operations are performed by using the input signals and weights. The weights are determined by training the ANN 210. The data center may also provide training data that is used to train the ANN 210.

The ANN 210 includes a plurality of layers. A layer, e.g., a convolutional layer 110, includes one or more analog circuitries that performs MAC operations. An analog circuitry may include various analog components, e.g., transistors, resistors, capacitors, diodes, other analog components, or some combination thereof. An analog circuitry can suffer from impairments in operations of the ANN 210, e.g., due to manufacturing mismatch, implementation mismatch, PVT variation, degradation of analog components, and so on. Such analog circuitry impairments can have negative impact on the performance of the ANN 210, e.g., they can cause inaccuracy in the outputs of the ANN 210. An analog circuitry may perform MAC operations based on an input signal, weights, and one or more compensation coefficients. The compensation coefficients, which may be received from the compensation module 260, are used to compensate analog circuitry impairments and to help the ANN 210 to converge to its optimum condition. The compensation coefficients in the ANN 210 may be constantly or periodically updated. The input signal, weights, and compensation coefficients may all be analog data.

The ANN 210 may also process digital data. For instance, the ANN 210 may include one or more ADC (analog-to-digital converter) units that can convert analog data from an analog circuitry to digital data to be input into a digital device. Additionally or alternatively, the ANN 210 may include one or more DAC (digital-to-analog converter) units that convert digital data from a digital device to analog data to be input into an analog circuitry.

The interface module 220 facilitates communications of the ANN system 200 with other systems. For example, the interface module 220 establishes communications between the ANN system 200 with an external database to receive data that can be used to train ANNs or input into ANNs to perform tasks. As another example, the interface module 220 supports the ANN system 200 to distribute ANNs to other systems, e.g., computing devices configured to apply ANNs to perform tasks.

The training module 230 trains the ANN 210 by using a training dataset. The training module 230 forms the training dataset. In an embodiment where the training module 230 trains the ANN 210 to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the ANN 210, and the rest of the training dataset may be held back as a validation subset used by the validation module 240 to validate performance of the ANN 210 after it has been trained. The portion of the training dataset not including the tuning subset and the validation subset may be used to train the ANN.

The training module 230 also determines hyperparameters for training the ANN 210. Hyperparameters are variables specifying the ANN 210 training process. Hyperparameters are different from parameters inside the ANN 210 (e.g., weights). In some embodiments, hyperparameters include variables determining the architecture of the ANN 210, such as number of hidden layers, etc. Hyperparameters also include variables which determine how the ANN is trained, such as batch size, number of epochs, etc. A batch size defines the number of training samples to work through before updating the parameters of the ANN 210. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the ANN 210. An epoch may include one or more batches. The number of epochs may be 2, 20, 500, 200, or even larger.

The training module 230 defines the architecture of the ANN 210, e.g., based on some of the hyperparameters. The architecture oft the ANN 210 includes an input layer, an output layer, and a plurality of hidden layers. The input layer of an ANN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the ANN 210 convert the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the ANN 210, the training module 230 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

After the training module 230 defines the architecture of the ANN 210, the training module 230 inputs a training dataset into the ANN 210. The training dataset includes a plurality of training samples. An example of a training sample includes an object in an image and a ground-truth label of the object. The training module 230 modifies the parameters inside the ANN 210 (i.e., internal parameters of the ANN 210) to minimize the error between labels of the training objects that are generated by the ANN 210 and the ground-truth labels of the objects. The internal parameters include weights of filters in the convolutional layers of the ANN 210. In some embodiments, the training module 230 uses a cost function to minimize the error.

The training module 230 may train the ANN 210 for a predetermined number of epochs. The number of epochs is a hyperparameter that defines the number of times that the DL algorithm will work through the entire training dataset. One epoch means that each sample in the training dataset has had an opportunity to update internal parameters of the ANN 210. After the training module 230 finishes the predetermined number of epochs, the training module 230 may stop updating the parameters in the ANN 210. The ANN 210 having the updated parameters is referred to as a trained ANN.

The validation module 240 verifies accuracy of the ANN 210 after it has been trained. In some embodiments, the validation module 240 inputs samples in a validation dataset into the ANN 210 and uses the outputs of the ANN 210 to determine the model accuracy. In some embodiments, a validation dataset may be formed of some or all the samples in the training dataset. Additionally or alternatively, the validation dataset includes additional samples, other than those in the training sets. In some embodiments, the validation module 240 determines may determine an accuracy score measuring the precision, recall, or a combination of precision and recall of the ANN 210. The validation module 240 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 240 may compare the accuracy score with a threshold score. In an example where the validation module 240 determines that the accuracy score of the augmented model is lower than the threshold score, the validation module 240 instructs the training module 230 to re-train the ANN 210. In one embodiment, the training module 230 may iteratively re-train the ANN 210 until the occurrence of a stopping condition, such as the accuracy measurement indication that the ANN 210 may be sufficiently accurate, or a number of training rounds having taken place.

The application module 250 applies the ANN 210, e.g., after the ANN 210 has been trained, validated, to perform tasks. For instance, the application module 250 inputs images into the ANN 210. The ANN 210 outputs classifications of objects in the images. As an example, the ANN 210 may be provisioned in a security setting to detect malicious or hazardous objects in images captured by security cameras. As another example, the ANN may be provisioned to detect objects (e.g., road signs, hazards, humans, pets, etc.) in images captured by cameras of an autonomous vehicle. The input to the ANN may be formatted according to a predefined input structure mirroring the way that the training dataset was provided to the ANN. The ANN may generate an output structure which may be, for example, a classification of the image, a listing of detected objects, a boundary of detected objects, or the like. In some embodiments, the application module 250 distributes the ANN 210 to other systems, e.g., computing devices in communication with the ANN system 200, for the other systems to apply the ANN 210 to perform the tasks.

The compensation module 260 compensates analog circuitry impairments in the ANN 210. The compensation module 260 computes compensation coefficients and provides the compensation coefficients to the ANN 210 so that analog circuitries in the ANN 210 may use the compensation coefficients to perform MAC operations. The compensation module 260 may constantly or periodically conduct compensation operations for the ANN 210, as new analog circuitry impairments may develop in the ANN 210 as the ANN 210 operates. In these compensation operations, the compensation module 260 may automatically tune the compensation coefficients, e.g., through an adaptive algorithm. The adaptive algorithm may change its behavior at the time it is run based on information available and on previously determined information. For instance, the compensation module 260 may use the adaptive algorithm to adjust a previously computed compensation coefficient (e.g., a compensation coefficient that is computed in a previous compensation operation) to an optimal value so that the ANN 210 can converge to its optimum condition.

In an example compensation operation, the compensation module 260 generates a training signal and feeds the training signal into the ANN 210. The ANN 210, after receiving the training signal, generates an output signal that may include one or more classifications of the training signal. The compensation module 260 generates an error signal by comparing the output signal with a reference signal that includes one or more ground-truth classifications of the training signal. Then the compensation module 260 generates a set of one or more compensation coefficients (“compensation coefficient set”) by minimizing the error signal. For instance, the compensation module 260 may conduct a search of a compensation coefficient that can lead to minimized error signal. The compensation module 260 may start the search with the current compensation coefficient and then updates the current compensation coefficient until the error signal is minimized. For the first compensation operation in the sequence, the compensation module 260 may start the search with a predetermined value or a random value. After the compensation module 260 generates the compensation coefficient set, the compensation module 260 can update the ANN 210 with the compensation coefficient set to compensate the analog circuitry impairments in the ANN 210. The updated ANN 210 can receive input signals and provide more accurate outputs.

In some embodiments, the compensation module 260 places an input signal and a training signal into a signal package, where the training signal may be a preamble and the input signal may be payload data. The compensation module 260 can sequentially feed the training signal and an input signal into the ANN 210. For instance, the compensation module 260 feeds the training signal into the ANN 210 first, and after the ANN 210 is updated with a compensation coefficient set generated based on the training signa, the compensation module 260 feeds the input signal into the ANN 210. That way, the interruption of the compensation operation to the normal operation of the ANN 210 can be minimized. Also, in embodiments where the ANN 210 is used for edge computing, the compensation operations by the compensation module 260 does not require assistance from the data center, as the compensation operations (e.g., the generation of the error signal) are based on training signals that can be generated at the edge. No input data from the data center is used. Therefore, the error signals would not reflect any error caused by corruption of input data from the data center, and the compensation operations are not misguided by input data corruption. Since the compensation operations do not require data transfer between the edge and the data center, consumption of communication bandwidth as well as latency due to data transfer can be reduced.

In some embodiments, the compensation module 260 may update the ANN 210 by feeding a compensation coefficient into an analog circuitry of the ANN 210, and the analog circuitry performs MAC operations based on the compensation coefficient. For instance, the analog circuitry may multiple the compensation coefficient with a weight and use the product as a new weight to perform MAC operations. In an embodiment, a compensation coefficient set may include a single compensation coefficient to be applied to multiple layers, or even all layers, of the ANN 210 (e.g., some or all of the convolutional layers in the ANN 210). For instance, each weight of these layers will be multiplied with the compensation coefficient in MAC operations by the ANN 210. In another embodiment, the compensation coefficient set may include a compensation coefficient to be applied to a single layer. An analog circuitry of the layer may multiple each weight of the layer with the compensation coefficient. The compensation coefficient set may include one or more other compensation coefficients for other layers of the ANN 210. In yet another embodiment, the compensation coefficient set may include a compensation coefficient to be applied to one or more filters. Each weight in the one or more filters will be multiplied with the compensation coefficient. The compensation coefficient set may include one or more other compensation coefficients to be applied to other filters. In yet another embodiment, the compensation coefficient set may include a compensation coefficient to be multiplied with a single weight. The compensation coefficient set may include one or more other compensation coefficients to be applied to other weights.

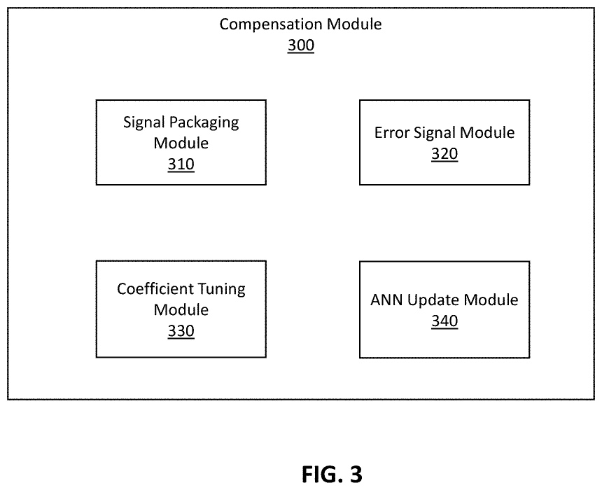

The compensation module 260 may conduct compensation operations at a predetermined frequency. There may be a fixed time interval between two compensation operations. Additionally or alternatively, the compensation module 260 may conduct a compensation operation in response to a determination that the accuracy of the ANN 210 (which may be determined by the validation module 240) becomes lower than a threshold accuracy. Also, the compensation module 260 may conduct a compensation operation in response to a detection of one or more analog circuitry impairments in the ANN 210, e.g., detection of a failure in an analog component, detection of an environment variation (e.g., PVT variation), detection of an implementation mismatch, detection of a manufacturing mismatch, detection of other types of analog circuitry impairments, or some combination thereof. In some embodiments, the compensation module 260 may include one or more hardware components placed adjacent to one or more analog circuitries of the ANN 210. More details regarding the compensation module 260 are provided below in conjunction with FIG. 3.

The memory 270 stores data received, generated, used, or otherwise associated with the ANN system 200. For example, the memory 270 stores the datasets used by the training module 230 and validation module 240. The memory 270 may also store data generated by the training module 230 and validation module 240, such as the hyperparameters for training the ANN 210, internal parameters of the ANN 210 (e.g., weights), etc. As another example, the memory 270 may store data associated with the compensation module 260, e.g., training signals, signal packages, reference signals, compensation coefficients, optimization algorithms, and so on.

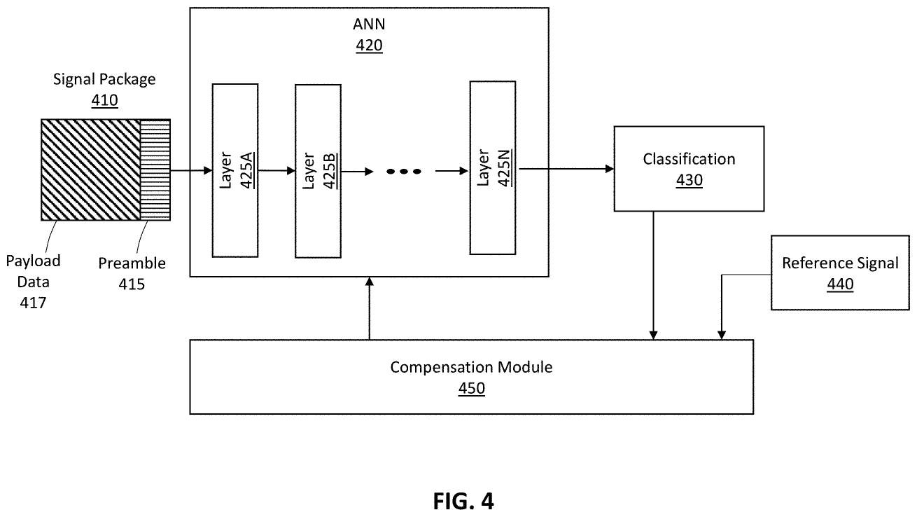

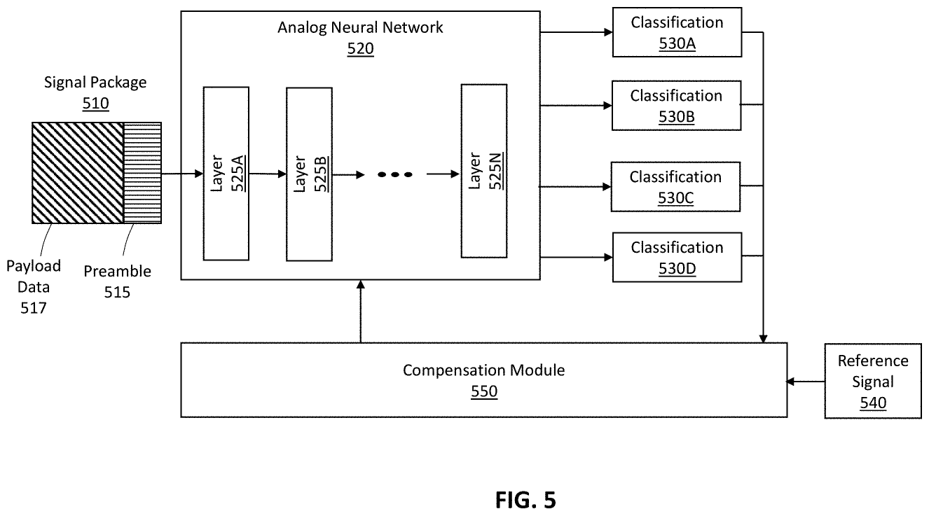

In the embodiment of FIG. 2, the memory 270 is a component of the ANN system 200. In other embodiments, the memory 270, or part of the memory 270, may be integrated with a component of the ANN system 200. For instance, the compensation module 260 may include a datastore that stores data received, generated, used, or otherwise associated with the compensation module 260. Alternatively, the memory 270 may be external to the ANN system 200 and communicate with the ANN system 200 through a network. More details regarding the ANN system 200 are provided below in conjunction with FIGS. 4 and 5.

Example Compensation Module

FIG. 3 is a block diagram of an example compensation module 300, in accordance with various embodiments. The compensation module 300 generates compensation coefficients to compensate analog circuitry impairments in ANNs. The compensation module 300 may be an embodiment of the compensation module 260 in FIG. 2. As shown in FIG. 3, the compensation module 300 includes a signal packaging module 310, an error signal module 320, a coefficient tuning module 330, and an ANN update module 340. In other embodiments, alternative configurations, different or additional components may be included in the compensation module 300. Further, functionality attributed to a component of the compensation module 300 may be accomplished by a different component included in the compensation module 300 or a different module.

The signal packaging module 310 forms signal packages for ANNs. A signal package for an ANN (e.g., the ANN 100 or the ANN 210) includes a preamble and payload data. The preamble is a training signal to be used to compute one or more compensation coefficients for the ANN. The payload data is an input signal to be used by the ANN to output a classification, e.g., a probability of the input signal belonging to a category. The signal packaging module 310 may sequentially feed the preamble and payload data into the ANN. For instance, the signal packaging module 310 first feeds the preamble into the ANN, and after the ANN is updated with the compensation coefficient computed based on the preamble, the signal packaging module 310 then feeds the preamble into the ANN. The preamble and input signal may be analog signals. In some embodiments, the signal packaging module 310 periodically generates signal packages, e.g., at a predetermined frequency, and periodically feeds the signal packages into the ANN. In other embodiments, the signal packaging module 310 may determine whether the ANN has any analog circuitry impairments, and after it identifies an analog circuitry impairment in the ANN, the signal packaging module 310 generates a signal package and feed the signal package into the ANN.

The training signal includes a training sample that has a ground-truth classification. In an example, the training sample is an image of an object in a category, and the ground-truth classification of the image is the category. For instance, the ground-truth classification of an image of a tree may be plant. The training signal may be associated with a reference signal that indicates the ground-truth classification. The reference signal, in some embodiments, may be a probability of the training sample belonging to the category. In the example where the training sample is an image of a tree, the reference signal may include a value indicating that the probability of the training sample belonging to the category is 100%. The value, e.g., may be 1.

In some embodiments, the training signal includes multiple training samples. For instance, the training signal may include a positive training sample that belongs to a category and a negative training sample that does not belong to the category. The reference signal may include data indicating a probability (e.g., 100%) of the positive training sample belonging to the category and a probability (e.g., 0%) of the negative training sample belonging to the category.

Training samples in a training signal may corresponds to multiple categories. A training signal may include different training samples, each of which corresponds to a different category. In some embodiments, a training sample is a positive training sample for the corresponding category but is a negative training sample for other categories. For each training sample, the reference signal of the training signal may include data indicating a probability (e.g., 100%) of the training sample belonging to the corresponding category. The reference signal may also include data indicating a probability (e.g., 0%) of the training sample belonging to another category. In an example, the training signal may include a first image showing a tree, a second image showing a dog, and a third image showing a person. The reference signal may include a first value (e.g., 1) indicating that the first image belongs to the plant category, a second value (e.g., 1) indicating that the second image belongs to the animal category, and a third value (e.g., 1) indicating that the third image belongs to the people category. The reference signals may also include additional values (e.g., 0) indicating that the first image does not belong to the animal category or the people category, or that the second image does not belong to the plant category or the people category, or that the third image does not belong to the plant category or the animal category.

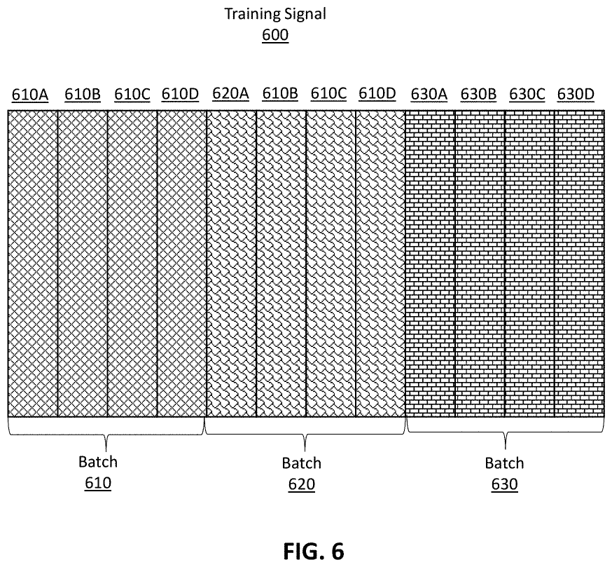

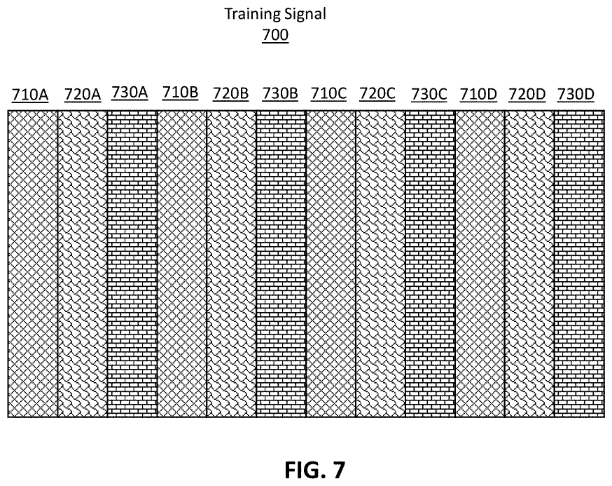

The signal packaging module 310 may arrange training samples in a training signal into batches. Each batch includes a subset of the training samples. Each training sample in a batch may correspond to a different classification from other training samples in the batch. In some embodiments (such as embodiments where the ANN outputs multiple classifications), a batch may include training samples for all the classifications. The signal packaging module 310 may arrange the training samples in a batch based on the sequence of the classifications in the output of the ANN. For instance, the first training sample in a batch belong to the category of the first classification in the output of the ANN, the second training sample in a batch belong to the category of the second classification in the output of the ANN, and so on. More details regarding signal package are provided below in conjunction with FIGS. 6 and 7.

The error signal module 320 generates error signals to be used to compute compensation coefficients. An error signal may be an analog signal. The error signal module 320 receives an output signal of an ANN, which is generated by the ANN based on a training signal in a signal package. The error signal module 320 also receives the reference signal associated with the training signal. The error signal module 320 generates an error signal by determining a difference between the output signal and the reference signal. In an example, the error signal e is the difference between the reference signal d and the output signal y:

e=d−y

In another example where the output signal and the reference signal each includes n classifications, the error signal e may be defined as the mean square of the difference between the output signal y and the reference signal d:

$$e = \frac{1}{n} {\sum }_{j = 1}^{n} {( {d}_{j} - {y}_{j} )}^{2}$$

where n is an integer that is larger than 1.

The coefficient tuning module 330 tunes compensation coefficients based on error signals from the error signal module 320. In some embodiments, the coefficient tuning module 330 computes compensation coefficients through a process of minimizing error signals. To compute a compensation coefficient set, the coefficient tuning module 330 may use a cost function to minimize an error signal. In an embodiment, the coefficient tuning module 330 may conduct a search for a compensation coefficient that relates to producing the least mean squares (LMSs) of the error signal. The coefficient tuning module 330 may use a search algorithm that starts with an initial value for the compensation coefficient. In some embodiments, the coefficient tuning module 330 uses an adaptive algorithm, and the initial value for the compensation coefficient is the value of the current compensation coefficient, i.e., the compensation coefficient that is being currently used in the operation of the ANN, which can be determined from the previous compensation operation. For the first compensation operation of the ANN, the initial value for the compensation coefficient may be a predetermined value, e.g., 1, or a random value. After the coefficient tuning module 330 determines the initial value for the compensation coefficient, the coefficient tuning module 330 repeatedly updates the value of the compensation coefficient to make the error signal smaller, until it is converged to a value that minimizes the error signal. The coefficient tuning module 330 can tune compensation coefficients automatically, without manual intervention.

In an example, the coefficient tuning module 330 may use a LMS equalizer that can be mathematically written as:

$$y [ i ] = {\prod }_{k = 1}^{p} {g}_{k} [ i ] \cdot x [ i - k ] , k ∈ \{ 1 , 2 , … , p \}$$

where i is an integer indicating an i-th round compensation process, y is output signal, gₖ is compensation coefficient, x is input signal, p is the number of layers in the ANN. The difference between the actual output signal y and the reference signal d defines the error signal e:

e[i]=d[i]−y[i]

The coefficient tuning module 330 uses an LMS algorithm to determine the next compensation coefficient gₖ[i+1] based on the error signal e and the current compensation coefficient gₖ[i]:

gₖ[i+1]=gₖ[i]−μ·e[i]·x[i−k]

where μ is step size. In some embodiments, the step size is determined based on a trade-off between the convergence speed and the convergence error of the LMS algorithm. The term μ·e[i] ·x[i−k] may be an approximation of the gradient of the MSE (mean square error) cost function. Therefore, the LMS algorithm may minimize the MSE cost function in an approximated sense due to the approximation on the gradient. In some embodiments, the step size is determined by randomly checking multiple numeral values and determining an optimal value that ensures the most efficient convergence. This equation is used for updating the tap which is then used to increment the weight of the equalizer periodically until the equalizer provide us with the most efficient convergence rate.

In other embodiments, the coefficient tuning module 330 may use algorithms other than LMS to compute compensation coefficients. In some embodiments, the coefficient tuning module 330 may compute a single compensation coefficient for an ANN in a compensation operation for the ANN. In other embodiments, the coefficient tuning module 330 may compute a set of compensation coefficients in a compensation operation for an ANN. Each compensation coefficient in the set may be for a different layer, a different filter, or a different weight of the ANN.

The ANN update module 340 updates ANNs with compensation coefficients. In some embodiments, the ANN update module 340 replaces existing compensation coefficients of an ANN with new compensation coefficients generated by the coefficient tuning module 330. An analog circuitry in the ANN may use one or more of the new compensation coefficients to perform MAC operations. In other embodiments, the ANN update module 340 updates the existing weights in the ANN based on compensation coefficients. For instance, the ANN update module 340 may generate a new set of weights for the ANN based on the compensation coefficient and the existing set of weights of the ANN. The ANN update module 340 may multiply an existing weight with the compensation coefficient to produce a new weight.

In some embodiments, the ANN update module 340 provides a single new compensation coefficient to the ANN. The analog circuitries in multiple (e.g., all) layers of the ANN will perform MAC operations based on input signals, weights, and the new compensation coefficient. In other embodiments, the ANN update module 340 provides a layer-specific compensation coefficient to a layer of an ANN. An analog circuitry in the layer will perform MAC operations based on input signals, weights, and the layer-specific compensation coefficient. Alternatively, the ANN update module 340 may provide filter-specific compensation coefficients or weight-specific compensation coefficients to an ANN.

Example Compensation Operations

FIG. 4 illustrates an example compensation operation for an ANN 420 that performs one-category classifications, in accordance with various embodiments. In FIG. 4, a signal package 410 is provided to the ANN 420. The signal package 410 includes a preamble 415 and payload data 417. The ANN 420 includes layers 425A-N. A layer may include an analog circuitry that performs MAC operations on analog data. An embodiment of ANN 420 may be the ANN 100 or the ANN 210. The ANN 420 is configured to determine whether inputs belong to a single category. An output of the ANN 420 may be a value indicating a probability of an input belong to the category.

The preamble 415 is fed into the ANN 420 first. The preamble 415 is a training signal that includes one or more training samples. The preamble 415 is associated with a reference signal 440 that indicates a ground-truth classification of each training sample in the preamble. For instance, the reference signal 440 may include a value of 1 for a training sample, indicating that the probability of a training sample belonging to the category is 100%.

The ANN 420 processes the preamble 415, e.g., by performing MAC operations on the preamble 415 and weights. The MAC operations are done by analog circuitries in the ANN 420. The weights have been determined through training the ANN 420. The ANN 420 determines a classification 430 of a training sample based on the MAC operations. The classification 430 may include a probability, which is determined by the ANN 420, of the training sample belong to the category. The classification 430 and the reference signal 440 are fed into a compensation module 450. An embodiment of the compensation module 450 is the compensation module 260 or the compensation module 300. The compensation module 450 generates an error signal based on the classification 430 and the reference signal 440. The error signal indicates degraded performance of the ANN 420, e.g., due to analog circuitry impairment. The compensation module 450 computes one or more compensation coefficients by minimizing the error signal, and updates the ANN 420 with the one or more compensation coefficients. After the ANN 420 is updated, the payload data 417 is fed into the ANN 420. The ANN 420 processes the payload data 417, e.g., by performing MAC operations based on the payload data 417, weights, and the one or more compensation coefficients. For instance, a compensation coefficient is multiplied with a weight in an MAC operation. The ANN 420 generates a new classification 430, which may be a value indicating a probability of the payload data 417 belong to the category.

In some embodiments, the ANN 420 processes the preamble 415 by performing MAC operations on the preamble 415, the weights, and one or more previously computed compensation coefficients. For instance, a previously computed compensation coefficient is multiplied with a weight in an MAC operation. The compensation module 450 may computes the one or more compensation coefficients based on the one or more previously computed compensation coefficients. The compensation module 450 may also replace the one or more previously computed compensation coefficients with the one or more compensation coefficients to update the ANN 420.

FIG. 5 illustrates an example compensation operation for an ANN 520 that performs multi-category classifications, in accordance with various embodiments. In FIG. 5, the ANN 520 performs four-category classifications. A signal package 510 is provided to the ANN 520. The signal package 510 includes a preamble 515 and payload data 517. The ANN 520 includes layers 525A-N. A layer may include an analog circuitry that performs MAC operations on analog data. An embodiment of ANN 520 may be the ANN 100 or the ANN 210. The ANN 520 is configured to determine whether an input belongs to any one of four categories. An output of the ANN 520 may be four values, each of which indicates a probability of an input belong to one of the four categories. In some embodiments, the ANN 520 may further determine a category of the input based on the highest probability.

The preamble 515 is fed into the ANN 520 first. The preamble 515 is a training signal that includes a plurality of training samples. Embodiments of the preamble 515 may be the training signal 600 in FIG. 6 or the training signal 700 in FIG. 7, which are described below. The preamble 515 is associated with a reference signal 540. The reference signal 540 includes a ground-truth classification of each training sample in the preamble. For instance, the reference signal 540 may include a value of 1 for a training sample, indicating that the probability of a training sample belonging to a category is 100%. The reference signal 540 may also include zero values for the training sample, indicating that the probabilities of the training sample belonging to other categories are 0%.

The ANN 520 processes the preamble 515, e.g., by performing MAC operations on the preamble 515 and weights. The MAC operations are done by analog circuitries in the ANN 520. The weights have been determined through training the ANN 520. The ANN 520 generates four classifications 530A-D (collectively referred to as “classifications 530” or “classification 530”) for each training sample. Each classification 530 corresponds to a different category and includes a probability, which is determined by the ANN 520, of a training sample belong to the corresponding category. For instance, the classification 530A may include a value of 0.5, indicating there is a 50% chance that the training sample belongs to the first category. The classification 530B may include a value of 0.2, indicating there is a 20% chance that the training sample belongs to the second category. The classification 530C may include a value of 0.1, indicating there is a 10% chance that the training sample belongs to the third category. The classification 530D may include a value of 0.7, indicating there is a 70% chance that the training sample belongs to the fourth category.

The classifications 530 and the reference signal 540 are fed into a compensation module 550. An embodiment of the compensation module 550 is the compensation module 260 or the compensation module 300. The compensation module 550 generates an error signal based on the output classification 530 and the reference signal 540. The error signal indicates degraded performance of the ANN 520, e.g., due to analog circuitry impairment. The compensation module 550 computes one or more compensation coefficients by minimizing the error signal, and updates the ANN 520 with the one or more compensation coefficients. After the ANN 520 is updated, the payload data 517 is fed into the ANN 520. The ANN 520 processes the payload data 517, e.g., by performing MAC operations based on the payload data 517, weights, and the one or more compensation coefficients. For instance, a compensation coefficient is multiplied with a weight in an MAC operation. The ANN 520 generates new classifications 530, each of which includes a value indicating a probability of the payload data 517 belong to one of the four categories.

In some embodiments, the ANN 520 processes the preamble 515 by performing MAC operations on the preamble 515, the weights, and one or more previously computed compensation coefficients. For instance, a previously computed compensation coefficient is multiplied with a weight in an MAC operation. The compensation module 550 may computes the one or more compensation coefficients based on the one or more previously computed compensation coefficients. The compensation module 550 may also replace the one or more previously computed compensation coefficients with the one or more compensation coefficients to update the ANN 520.

Example Training Signals

FIG. 6 illustrates an example training signal 600 for a compensation operation, in accordance with various embodiments. In some embodiments, the training signal 600 may be a preamble of a signal package, e.g., the signal package 510. The training signal 600 can be fed into an ANN to compute a compensation coefficient that will be used to compensate an analog circuitry impairment in the ANN. In the embodiment of FIG. 6, the ANN determines classifications of input signals with respect to four categories. For instance, for each of the four categories, the ANN outputs a probability indicating a likelihood of the input signal belongs to the category.

For purpose of illustration, the training signal 600 includes three batches 610, 620, and 630. The training signal 600 may be associated with a reference signal that also includes three reference batches, each of which corresponds to one of the three batches 610, 620, and 630. Each batch corresponds to a stage in the compensation operation, which includes an update in the value of the compensation coefficient. For instance, the batch 610 is fed into the ANN first, and the ANN generates a first output. The value of the compensation coefficient is updated to a first value based on the first output of the ANN and a reference batch that corresponds to the batch 610. Next, the batch 620 is fed into the ANN, and the ANN generates a second output. The first value of the compensation coefficient is updated to a second value based on the second output of the ANN and a reference batch that corresponds to the batch 620. Further, the batch 630 is fed into the ANN, and the ANN generates a third output. The second value of the compensation coefficient is updated to a third value based on the third output of the ANN and a reference batch that corresponds to the batch 630. The third value may be the final value of the compensation coefficient in the compensation operation. In other embodiments, the training signal 600 may include fewer or more batches, and the compensation operation may include fewer or more stages.

As shown in FIG. 6, the ANN can output four categories for the input signal. Accordingly, each batch includes four training samples: the batch 610 includes training samples 610A-D, the batch 620 includes training samples 620A-D, and the batch 630 includes training samples 630A-D. Each training sample in a batch may correspond to a different category. Each batch is associated with a reference batch that includes ground-truth classifications of the training samples in the batch. In an example, the training samples 610A, 620A, and 630A belong to the first category; the training samples 610B, 620B, and 630B belong to the second category; the training samples 610C, 620C, and 630C belong to the third category, and the training samples 610D, 620D, and 630D belong to the fourth category.

In some embodiments, the compensation operation includes feeding the training signal 600 may be fed into the ANN once (i.e., one epoch). In other embodiments, the compensation operation includes feeding the training signal 600 into the ANN multiple times (i.e., multiple epochs), e.g., till an accuracy of the ANN (which may be determined by the validation module 240) reaches an accuracy threshold. In an epoch, the value of the compensation coefficient may be updated three times since the training signal 600 includes three batches 610, 620, and 630.

FIG. 7 illustrates another example training signal for a compensation operation, in accordance with various embodiments. In some embodiments, the training signal 700 may be a preamble of a signal package, e.g., the signal package 510. The training signal 700 can be fed into an ANN to compute a compensation coefficient that will be used to compensate an analog circuitry impairment in the ANN. In the embodiment of FIG. 7, the ANN determines classifications of input signals with respect to four categories. For instance, for each of the four categories, the ANN outputs a probability indicating a likelihood of the input signal belongs to the category.

For purpose of illustration, the training signal 700 includes 12 training samples 710A-D, 720A-D, and 730A-D. In other embodiments, the training signal 700 may include a different number of training samples. Each training sample may belong to one of the four categories. In an example, the training samples 710A, 720A, and 730A belong to the first category; the training samples 710B, 720B, and 730B belong to the second category; the training samples 710C, 720C, and 730C belong to the third category, and the training samples 710D, 720D, and 730D belong to the fourth category. The training signal 700 may be associated with a reference signal that includes ground-truth classification of the training samples 710A-D, 720A-D, and 730A-D.

In some embodiments, the compensation operation includes feeding the training signal 700 may be fed into the ANN. The ANN generates an output signal, which may include four classifications of each training sample. Each of the four classifications corresponds to one of the four categories. For instance, for each training sample, the output signal includes four probabilities, each indicating a likelihood of the training sample belonging to one of the four categories. The compensation coefficient is computed based on the output signal of the ANN and the reference signal.

In some embodiments, the training signal 700 is fed into the ANN once (i.e., one epoch). In other embodiments, the compensation operation includes feeding the training signal 700 into the ANN multiple times (i.e., multiple epochs), e.g., till an accuracy of the ANN (which may be determined by the validation module 240) reaches an accuracy threshold. Each epoch may include an update in the value of the compensation coefficient.

FIGS. 6 and 7 provides two example formats for training signals used to compensate analogy circuitry impairments in ANNs that perform multi-category classifications. In other embodiments, different training signal formats may be used for ANNs performing multi-category classifications. For instance, a training signal may include different numbers of training samples for different categories. Some training signals may not include any training samples for a category.

Example Method for Compensating Analog Circuitry Impairments

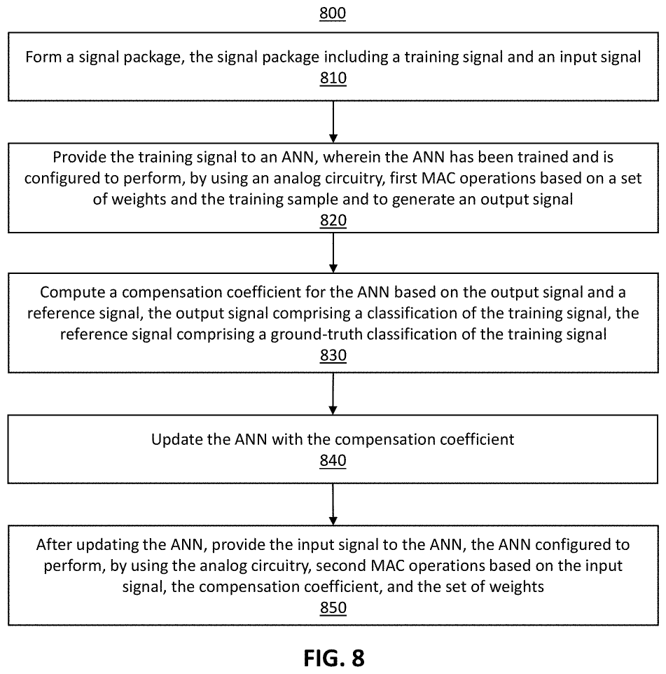

FIG. 8 is a flowchart showing an example method for compensating analog circuitry impairments in an ANN, in accordance with various embodiments. The method 800 may be performed by the compensation module 300 described above in conjunction with FIG. 3. Although the method 800 is described with reference to the flowchart illustrated in FIG. 8, many other methods for compensating analog circuitry impairments in an ANN may alternatively be used. For example, the order of execution of the steps in FIG. 8 may be changed. As another example, some of the steps may be changed, eliminated, or combined.

The compensation module 300 forms 810 a signal package, the signal package including a training signal and an input signal. The training signal may be a preamble of the signal package. In some embodiments, the training signal may include a plurality of batches. Each batch includes a plurality of training samples and each training sample in a batch may correspond to a different ground-truth classification of a plurality of ground-truth classifications. In other embodiments, the training signal may include a plurality of subsets. Each subset includes one or more training samples that correspond to a same ground-truth classification of a plurality of ground-truth classifications. In some embodiments, the compensation module 300 forms 810 the signal package periodically, e.g., at a predetermined frequency. In other embodiments, the compensation module 300 identifies an impairment of the analog circuitry, and after identifying the impairment of the analog circuitry, forms the signal package.

The compensation module 300 provides 820 the training signal to an ANN. The analog neural network has been trained. The ANN is configured to perform, by using an analog circuitry, first MAC operations based on a set of weights and the training sample and to generate an output signal. The set of weights may be determined through the training of the ANN.

The compensation module 300 computes 830 a compensation coefficient for the analog neural network based on the output signal and a reference signal, the output signal comprising a classification of the training signal, the reference signal comprising a ground-truth classification of the training signal. In some embodiments, the compensation module 300 generates an error signal by comparing the output signal with the reference signal. Then the compensation module 300 determines a value of the compensation coefficient by minimizing the error signal. In some embodiments, such as embodiments where the first MAC operations are further based on a precedent compensation coefficient, the compensation module 300 determines a value of the compensation coefficient by updating a value of the precedent compensation coefficient till the error signal is minimized.

The reference signal may include a plurality of ground-truth classifications that includes the ground-truth classification. The output signal may include a plurality of classifications that includes the classification. Each ground-truth classification in the reference signal corresponds to a same category as a classification in the output signal.

The compensation module 300 updates 840 the analog neural network with the compensation coefficient. In some embodiments, such as embodiments where the first MAC operations are further based on a precedent compensation coefficient, the compensation module 300 replaces the precedent compensation coefficient with the compensation coefficient.

The compensation module 300, after updating the analog neural network, provides 850 the input signal to the analog neural network, the analog neural network configured to perform, by using the analog circuitry, second MAC operations based on the input signal, the compensation coefficient, and the set of weights. In some embodiments, the second MAC operations include multiplying the compensation coefficient with a weight in the set of weights. The second MAC operations may include multiplying the compensation coefficient with each of the weights in the set of weights. In other embodiments, the second MAC operations may include multiplying a different compensation coefficient with a different weight in the set of weights. The compensation module 300 may compute the different compensation coefficient based on the output signal and the reference signal.

Example Computing System

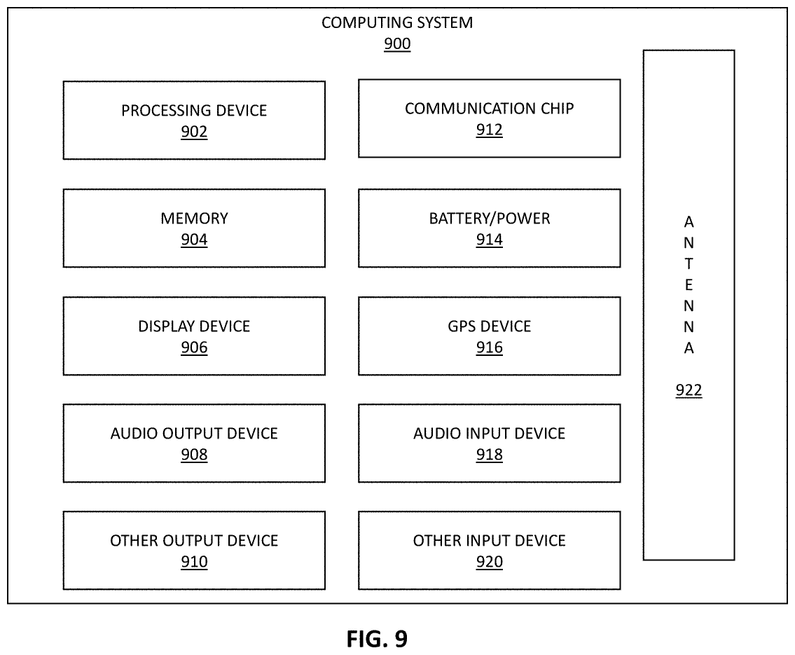

FIG. 9 is a block diagram of an example computing system 900, in accordance with various embodiments. A number of components are illustrated in FIG. 9 as included in the computing system 900, but any one or more of these components may be omitted or duplicated, as suitable for the application. In some embodiments, some or all of the components included in the computing system 900 may be attached to one or more motherboards. In some embodiments, some or all of these components are fabricated onto a single system on a chip (SoC) die. Additionally, in various embodiments, the computing system 900 may not include one or more of the components illustrated in FIG. 9, but the computing system 900 may include interface circuitry for coupling to the one or more components. For example, the computing system 900 may not include a display device 906, but may include display device interface circuitry (e.g., a connector and driver circuitry) to which a display device 906 may be coupled. In another set of examples, the computing system 900 may not include an audio input device 918 or an audio output device 908, but may include audio input or output device interface circuitry (e.g., connectors and supporting circuitry) to which an audio input device 918 or audio output device 908 may be coupled.

The computing system 900 may include a processing device 902 (e.g., one or more processing devices). An embodiment of the processing device 902 is a processing device 902 in FIG. 1. The computing system 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable to perform operations for compensating analog circuitry impairments in ANNs, e.g., the method 800 described above in conjunction with FIG. 8, some or all of the operations performed by the compensation module 260 described above in conjunction with FIG. 2, or some or all of the operations performed by the compensation module 300 described above in conjunction with FIG. 3. The instructions stored in the one or more non-transitory computer-readable media may be executed by the processing device 902.

In some embodiments, the computing system 900 may include a communication chip 912 (e.g., one or more communication chips). For example, the communication chip 912 may be configured for managing wireless communications for the transfer of data to and from the computing system 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing system 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing system 900 may include battery/power circuitry 914. The battery/power circuitry 914 may include one or more energy storage devices (e.g., batteries or capacitors) and/or circuitry for coupling components of the computing system 900 to an energy source separate from the computing system 900 (e.g., AC line power).

The computing system 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing system 900 may include an audio output device 908 (or corresponding interface circuitry, as discussed above). The audio output device 908 may include any device that generates an audible indicator, such as speakers, headsets, or earbuds, for example.

The computing system 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing system 900 may include a GPS device 916 (or corresponding interface circuitry, as discussed above). The GPS device 916 may be in communication with a satellite-based system and may receive a location of the computing system 900, as known in the art.

The computing system 900 may include an other output device 910 (or corresponding interface circuitry, as discussed above). Examples of the other output device 910 may include an audio codec, a video codec, a printer, a wired or wireless transmitter for providing information to other devices, or an additional storage device.

The computing system 900 may include an other input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register file ID) reader.

The computing system 900 may have any desired form factor, such as a handheld or mobile computing system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing system 900 may be any other electronic device that processes data.

### Select Examples

The following paragraphs provide various examples of the embodiments disclosed herein.

Example 1 provides a method, including forming a signal package, the signal package including a training signal and an input signal; providing the training signal to an ANN, where the ANN has been trained and is configured to perform, by using an analog circuitry, first MAC operations based on a set of weights and the training sample to generate an output signal; computing a compensation coefficient for the ANN based on the output signal and a reference signal, the output signal including a classification of the training signal, the reference signal including a ground-truth classification of the training signal; updating the ANN with the compensation coefficient; and after updating the ANN, providing the input signal to the ANN, the ANN configured to perform, by using the analog circuitry, second MAC operations based on the input signal, the compensation coefficient, and the set of weights.

Example 2 provides the method of example 1, where the second MAC operations include multiplying the compensation coefficient with a weight in the set of weights.

Example 3 provides the method of example 1, where computing the compensation coefficient includes generating an error signal by comparing the output signal with the reference signal; and determining a value of the compensation coefficient by minimizing the error signal.

Example 4 provides the method of example 1, where the first MAC operations are further based on a previously computed compensation coefficient, and updating the ANN with the compensation coefficient includes replacing the previously computed compensation coefficient with the compensation coefficient.

Example 5 provides the method of example 4, where computing the compensation coefficient includes generating an error signal by comparing the output signal with the reference signal; and determining a value of the compensation coefficient by updating a value of the previously computed compensation coefficient till the error signal is minimized.

Example 7 provides the method of example 1, where forming the signal package includes identifying an impairment of the analog circuitry; and after identifying the impairment of the analog circuitry, forming the signal package.

Example 7 provides the method of example 1, where forming the signal package includes periodically forming the signal package at a predetermined frequency.

Example 8 provides the method of example 1, where the reference signal includes a plurality of ground-truth classifications that includes the ground-truth classification, the output signal includes a plurality of classifications that includes the classification, and each ground-truth classification in the reference signal corresponds to a same category as a classification in the output signal.

Example 9 provides the method of example 8, where the training signal includes a plurality of batches, each batch includes a plurality of training samples, each training sample in a batch corresponds to a different ground-truth classification of the plurality of ground-truth classifications.

Example 10 provides the method of example 8, where the training signal includes a plurality of subsets, each subset includes one or more training samples that correspond to a same ground-truth classification of the plurality of ground-truth classifications.

Example 11 provides one or more non-transitory computer-readable media storing instructions executable to perform operations, the operations including forming a signal package, the signal package including a training signal and an input signal; providing the training signal to an ANN, where the ANN has been trained and is configured to perform, by using an analog circuitry, first MAC operations based on a set of weights and the training sample to generate an output signal; computing a compensation coefficient for the ANN based on the output signal and a reference signal, the output signal including a classification of the training signal, the reference signal including a ground-truth classification of the training signal; updating the ANN with the compensation coefficient; and after updating the ANN, providing the input signal to the ANN, the ANN configured to perform, by using the analog circuitry, second MAC operations based on the input signal, the compensation coefficient, and the set of weights.

Example 12 provides the one or more non-transitory computer-readable media of example 11, where the second MAC operations include multiplying the compensation coefficient with a weight in the set of weights.

Example 13 provides the one or more non-transitory computer-readable media of example 11, where computing the compensation coefficient includes generating an error signal by comparing the output signal with the reference signal; and determining a value of the compensation coefficient by minimizing the error signal.

Example 14 provides the one or more non-transitory computer-readable media of example 11, where the first MAC operations are further based on a previously computed compensation coefficient, and updating the ANN with the compensation coefficient includes replacing the previously computed compensation coefficient with the compensation coefficient.

Example 15 provides the one or more non-transitory computer-readable media of example 11, where the reference signal includes a plurality of ground-truth classifications that includes the ground-truth classification, the output signal includes a plurality of classifications that includes the classification, and each ground-truth classification in the reference signal corresponds to a same category as a classification in the output signal.

Example 16 provides an apparatus, including a computer processor for executing computer program instructions; and one or more non-transitory computer-readable media storing computer program instructions executable by the computer processor to perform operations including providing a training signal to an analog neural network, where the analog neural network is configured to perform, by using an analog circuitry, first multiply-accumulate (MAC) operations based on a set of weights and the training sample and to generate an output signal, computing a compensation coefficient based on the output signal and a reference signal, the output signal including a classification of the training signal, the reference signal including a ground-truth classification of the training signal, updating the analog neural network with the compensation coefficient, and after updating the analog neural network, providing an input signal to the analog neural network, the analog neural network configured to perform, by using the analog circuitry, second MAC operations based on the input signal, the compensation coefficient, and the set of weights.

Example 17 provides the apparatus of example 16, where the second MAC operations include multiplying the compensation coefficient with a weight in the set of weights.

Example 18 provides the apparatus of example 16, where computing the compensation coefficient includes generating an error signal by comparing the output signal with the reference signal; and determining a value of the compensation coefficient by minimizing the error signal.

Example 19 provides the apparatus of example 16, where the first MAC operations are further based on a previously computed compensation coefficient, and updating the analog neural network with the compensation coefficient includes replacing the previously computed compensation coefficient with the compensation coefficient.

Example 20 provides the apparatus of example 19, where computing the compensation coefficient includes generating an error signal by comparing the output signal with the reference signal; and determining a value of the compensation coefficient by updating a value of the previously computed compensation coefficient till the error signal is minimized.

Example 21 provides the apparatus of example 16, where the operations further include forming a signal package, the signal package including the training signal and the input signal, where the training signal is a preamble of the signal package.

Example 22 provides the apparatus of example 16, where forming the signal package includes forming the signal package after identifying an impairment of the analog circuitry; or periodically forming the signal package at a predetermined frequency.

Example 23 provides the apparatus of example 16, where the reference signal includes a plurality of ground-truth classifications that includes the ground-truth classification, the output signal includes a plurality of classifications that includes the classification, and each ground-truth classification in the reference signal corresponds to a same category as a classification in the output signal.

Example 24 provides the apparatus of example 23, where the training signal includes a plurality of batches, each batch includes a plurality of training samples, each training sample in a batch corresponds to a different ground-truth classification of the plurality of ground-truth classifications.

Example 25 provides the apparatus of example 23, where the training signal includes a plurality of subsets, each subset includes one or more training samples that correspond to a same ground-truth classification of the plurality of ground-truth classifications.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method, comprising:
providing a training signal to an analog neural network, wherein the analog neural network is configured to perform, by using an analog circuitry, first multiply-accumulate (MAC) operations based on a set of weights and the training sample and to generate an output signal;
computing a compensation coefficient based on the output signal and a reference signal, the output signal comprising a classification of the training signal, the reference signal comprising a ground-truth classification of the training signal;
updating the analog neural network with the compensation coefficient; and
after updating the analog neural network, providing an input signal to the analog neural network, the analog neural network configured to perform, by using the analog circuitry, second MAC operations based on the input signal, the compensation coefficient, and the set of weights.

2. The method of claim 1, wherein the second MAC operations comprise:
multiplying the compensation coefficient with a weight in the set of weights.

3. The method of claim 1, wherein computing the compensation coefficient comprises:
generating an error signal by comparing the output signal with the reference signal; and
determining a value of the compensation coefficient by minimizing the error signal.

4. The method of claim 1, wherein the first MAC operations are further based on a previously computed compensation coefficient, and updating the analog neural network with the compensation coefficient comprises replacing the previously computed compensation coefficient with the compensation coefficient.

5. The method of claim 4, wherein computing the compensation coefficient comprises:
generating an error signal by comparing the output signal with the reference signal; and
determining a value of the compensation coefficient by updating a value of the previously computed compensation coefficient till the error signal is minimized.

6. The method of claim 1, further comprising:
forming a signal package, the signal package including the training signal and the input signal, wherein the training signal is a preamble of the signal package.

7. The method of claim 1, wherein forming the signal package comprises:
forming the signal package after identifying an impairment of the analog circuitry; or
periodically forming the signal package at a predetermined frequency.

8. The method of claim 1, wherein the reference signal comprises a plurality of ground-truth classifications that includes the ground-truth classification, the output signal comprises a plurality of classifications that includes the classification, and each ground-truth classification in the reference signal corresponds to a same category as a classification in the output signal.

9. The method of claim 8, wherein the training signal comprises a plurality of batches, each batch includes a plurality of training samples, each training sample in a batch corresponds to a different ground-truth classification of the plurality of ground-truth classifications.

10. The method of claim 8, wherein the training signal comprises a plurality of subsets, each subset includes one or more training samples that correspond to a same ground-truth classification of the plurality of ground-truth classifications.

11. One or more non-transitory computer-readable media storing instructions executable to perform operations, the operations comprising:
providing a training signal to an analog neural network, wherein the analog neural network is configured to perform, by using an analog circuitry, first multiply-accumulate (MAC) operations based on a set of weights and the training sample and to generate an output signal;
computing a compensation coefficient based on the output signal and a reference signal, the output signal comprising a classification of the training signal, the reference signal comprising a ground-truth classification of the training signal;
updating the analog neural network with the compensation coefficient; and
after updating the analog neural network, providing an input signal to the analog neural network, the analog neural network configured to perform, by using the analog circuitry, second MAC operations based on the input signal, the compensation coefficient, and the set of weights.

12. The one or more non-transitory computer-readable media of claim 11, wherein the second MAC operations comprise:
multiplying the compensation coefficient with a weight in the set of weights.

13. The one or more non-transitory computer-readable media of claim 11, wherein computing the compensation coefficient comprises:
generating an error signal by comparing the output signal with the reference signal; and
determining a value of the compensation coefficient by minimizing the error signal.

14. The one or more non-transitory computer-readable media of claim 11, wherein the first MAC operations are further based on a previously computed compensation coefficient, and updating the analog neural network with the compensation coefficient comprises replacing the previously computed compensation coefficient with the compensation coefficient.

15. The one or more non-transitory computer-readable media of claim 11, wherein the reference signal comprises a plurality of ground-truth classifications that includes the ground-truth classification, the output signal comprises a plurality of classifications that includes the classification, and each ground-truth classification in the reference signal corresponds to a same category as a classification in the output signal.

16. An apparatus, comprising:
a computer processor for executing computer program instructions; and
one or more non-transitory computer-readable media storing computer program instructions executable by the computer processor to perform operations comprising:
providing a training signal to an analog neural network, wherein the analog neural network is configured to perform, by using an analog circuitry, first multiply-accumulate (MAC) operations based on a set of weights and the training sample and to generate an output signal,
computing a compensation coefficient based on the output signal and a reference signal, the output signal comprising a classification of the training signal, the reference signal comprising a ground-truth classification of the training signal,
updating the analog neural network with the compensation coefficient, and
after updating the analog neural network, providing an input signal to the analog neural network, the analog neural network configured to perform, by using the analog circuitry, second MAC operations based on the input signal, the compensation coefficient, and the set of weights.

17. The apparatus of claim 16, wherein the second MAC operations comprise:
multiplying the compensation coefficient with a weight in the set of weights.

18. The apparatus of claim 16, wherein computing the compensation coefficient comprises:
generating an error signal by comparing the output signal with the reference signal; and
determining a value of the compensation coefficient by minimizing the error signal.

19. The apparatus of claim 16, wherein the first MAC operations are further based on a previously computed compensation coefficient, and updating the analog neural network with the compensation coefficient comprises replacing the previously computed compensation coefficient with the compensation coefficient.

20. The apparatus of claim 19, wherein computing the compensation coefficient comprises:
generating an error signal by comparing the output signal with the reference signal; and
determining a value of the compensation coefficient by updating a value of the previously computed compensation coefficient till the error signal is minimized.

21. The apparatus of claim 16, wherein the operations further comprise:
forming a signal package, the signal package including the training signal and the input signal, wherein the training signal is a preamble of the signal package.

22. The apparatus of claim 16, wherein forming the signal package comprises:
forming the signal package after identifying an impairment of the analog circuitry; or
periodically forming the signal package at a predetermined frequency.

23. The apparatus of claim 16, wherein the reference signal comprises a plurality of ground-truth classifications that includes the ground-truth classification, the output signal comprises a plurality of classifications that includes the classification, and each ground-truth classification in the reference signal corresponds to a same category as a classification in the output signal.

24. The apparatus of claim 23, wherein the training signal comprises a plurality of batches, each batch includes a plurality of training samples, each training sample in a batch corresponds to a different ground-truth classification of the plurality of ground-truth classifications.

25. The apparatus of claim 23, wherein the training signal comprises a plurality of subsets, each subset includes one or more training samples that correspond to a same ground-truth classification of the plurality of ground-truth classifications.
